(19) United States
(12) Patent Application Publication
(10) Pub. No.: US 2006/0073245 A1
(43) Pub. Date: Apr. 6, 2006

(54) Ready-to-fill pre-moistened antimicrobial polymer-based foodstuff wrapper

(75) Inventors: Klaus-Dieter Hammer, Mainz (DE); Martina Koenig, Wiesbaden (DE); Gerhard Grolig, Moerfelden-Walldorf (DE)

Correspondence Address: CONNOLLY BOVE LODGE & HUTZ LLP, SUITE 800, 1990 M STREET NW, WASHINGTON, DC, 20036-3425, US

(73) Assignee: kalle GmbH & Co. KG, Wiesbaden (DE)

(21) Appl. No.: 10/521,146

(22) PCT Filed: Jul. 14, 2003
(86) PCT No.: PCT/EP03/07586

§ 371 Date: Jan. 13, 2005

(30) Foreign Application Priority Data
Jul. 15, 2002 (DE) 102318115

(51) Int. Cl. A21D 13/00

(52) U.S. Cl. 426/138

(57) ABSTRACT

The invention relates to an antimicrobial, tubular, single- or multilayer polymer-based foodstuff casing, premoistened so as to be ready-to-fill, which comprises, as antimicrobial constituent, an alkyl para-hydroxybenzoate having from 1 to 10 carbon atoms in the alkyl moiety, and/or a salt thereof, and also, if appropriate, comprises another antimicrobial agent, in particular one which reduces water activity, i.e. a_{w} value. This casing is preferably used as sausage casing.

The invention relates to an antimicrobial, tubular, single- or multilayer polymer-based foodstuff casing, premoistened so as to be ready-to-fill. It also relates to the use of this casing as synthetic sausage-casing.

There are known single- and multilayer foodstuff casings composed of a very wide variety of materials. Casings based on collagen, on (regenerated) cellulose, on polyamide, polyolefin, or on other (synthetic) polymers, or else on mixtures of these, are widely used. Synthetic sausage-casings are generally treated with water immediately prior to filling, in order to make them more conformable and extensible. The treatment with water is not only very complicated but also creates extreme hygiene hazards, because the water-treatment bath can cause contamination with a very wide variety of microbes. Furthermore, the usual water-treatment time of from about 15 to 30 min cannot achieve uniform diffusion of the water across the entire cross section of the casing.

As an alternative to this, casings are supplied moistened so as to be ready-to-fill. These are frequently cellulose hydrate casings with a moisture content of from about 20 to 35% by weight. In order to inhibit dry-out during storage and transport, the casings are provided with a packaging impermeable to water vapor. If the conditions maintained during production and packaging have not been absolutely sterile, the premoistened casings can have contamination by bacteria, fungi, yeasts, or other microorganisms, and these then subsequently encounter ideal growth conditions, particularly when the casings are stored at relatively high ambient temperatures. The result is then, by way of example, undesired mold spots. Mold fungi also form cellulolyic enzymes which attack the actual cellulose casings and finally can destroy them. Attempts have therefore been made to find ways of inhibiting the undesired spread of microorganisms on the premoistened casings.

U.S. Pat. No. 4,867,204 (=DE-A 27 21 427) discloses a method of this type. This method inhibits the growth of the microorganisms via a water-soluble antimycotic agent. The antimycotic agent is preferably propylene glycol, potassium propionate, sodium propionate, or calcium propionate, potassium sorbate, sodium sorbate, or calcium sorbate, propionic acid, or a lower alkyl para-hydroxybenzoate.

DE-A 195 40 082 discloses tubular foodstuff casings which have been conditioned, i.e. premoistened so as to be ready-to-fill, and which are based on plastics, such as polyamides, polyesters, or a mixture of these. These casings known as polymer casings are preferably shirred to give shirred sticks and surrounded by an outer packaging impermeable to water vapor. In order to inhibit contamination with microorganisms during storage, the water bath used for the conditioning of the casing may comprise a preservative. The preservative is preferably a mineral acids, such as hydrochloric acid or phosphoric acid, or an organic acid, such as formic acid, acetic acid, propionic acid, tartaric acid, succinic acid, malic acid, citric acid, or ascorbic acid. The content of acid in the bath is generally from 0.1 to 10% by weight, and the pH of the bath is correspondingly from about 0 to 5. The casing is present in this bath for at least 15 minutes. Prior to conditioning with the aqueous acidic phase, the casing may also be treated with an oil emulsion. The preservatives mentioned have not dependable effect at an acceptable concentration. That is attributed to slow reaction of the acids mentioned with the polyamide of the casing material, thus increasing the pH and decreasing the effectiveness of the preservatives. At higher dosage, the acids in turn have an adverse effect on the sausage meat emulsion (taste, coagulation).

DE-A 198 60 142 discloses multilayer, biaxially oriented tubular polyamide-based films which have been conditioned so as to be ready-to-fill. The tubular films are conditioned via spraying with water, which may, if appropriate, comprise a conventional fungicide, such as a quaternary ammonium compound, and/or a conventional preservative. Both sides of the tubular film are preferably sprayed.

These shortcomings gave rise to the technical object of providing ready-to-fill premoistened tubular plastics casings which have dependable and longlasting preservation properties, but where the agent used for preservation does not attack the casing material or adversely affect the foodstuff subsequently used as filling. The agent is moreover to have a broad spectrum of action, i.e. be effective against a maximum number of the types of the microorganism, and is to be effective irrespective of pH. The preservative is moreover, if at all possible, to be capable of application to the inner and/or outer side of the casing without an additional step in the process. It is preferably to be capable of combination with agents which improve peelability and to be capable of application together with these.

The object is achieved via the use of alkyl para-hydroxybenzoates and/or of their salts. It has been found here that antimicrobial activity rises with chain length in the alkyl moiety. Butyl para-hydroxybenzoates are therefore more effective than the corresponding ethyl ester, which in turn is more effective than the methyl ester.

The invention therefore provides an antimicrobial, tubular, single- or multilayer polymer-based foodstuff casing premoistened so as to be ready-to-fill, which comprises, as antimicrobial constituent, an alkyl para-hydroxybenzoate and/or a salt thereof.

The alkyl para-hydroxybenzoate or its salt (both also referred to below by the abbreviated term PHB ester) advantageously contains from 1 to 10, preferably from 1 to 6, particularly preferably from 2 to 5, carbon atoms in the alkyl moiety, which is generally not a branched moiety. The salt mentioned is preferably a potassium or sodium salt. Unlike most preservatives, the PHB esters have antimicrobial action particularly irrespective of the pH, i.e. they are effective in an acidic medium or in an alkaline medium against fungi, yeasts and bacteria (E. coli, Salmonellae, Staphylococci, etc.). The antimicrobial properties are attributed to an interaction with the cell membrane and with the proteins in the cell of the microorganisms. In this process, the lipid membranes are penetrated and damaged.

If appropriate, the PHB ester has been combined with other antimicrobial agents. These are in particular organic acids, such as formic acid, propionic acid, or sorbic acid, or else salts thereof, such as sodium sorbate or potassium sorbate. Because the sorbates have no fungicidal action, only the undissociated sorbic acid having this action, the pH of the solution is to be lowered via addition of lactic acid, which itself has bioacidic properties, or of other mild organic acids, sufficiently to generate a sufficient amount of sorbic acid. To this end, the pH should be adjusted below 6. However, the precipitation of sorbic acid has to be inhibited here. Other antimicrobial substances are those which reduce water activity, i.e. lower the a_{w} value. These are in particular polyhydric aliphatic alcohols, such as glycerol or propanediol. The term “antimicrobial” in the present application means bactericidal, bacteriostatic, fungicidal, and/or fungistatic. Another particular bacterial substance which may be used is 1,2-benzoisothiazolin-3-one.

The content of all of the antimicrobial agents together in the solution used for premoistening is generally from about 0.1 to 8% by weight, preferably from 0.2 to 2% by weight.

The PHB ester is advantageously applied in one step to the inner and/or outer side of the tubular film with the water serving for premoistening. In one particularly simple embodiment, an aqueous solution is applied by spraying and comprises the preservative(s) and, if appropriate, other constituents. Another possible method of external preparation is to pass the (collapsed) casing through a saturation trough or use external spraying prior to finishing processes. The general method of internal preparation is use of a spray mandrel during shirring of the casing. Application of the premoistening solution to the inner and the outer side is particularly advisable in the case of those multilayer casings which have internal water-vapor-barrier layers.

The aqueous composition used for pretreatment with water in the case of ready-to-fill shirred sticks may moreover comprise components which make the casing easy to peel (easy-peel preparation). However, easy-peel capability is not desirable for every application. Indeed, relatively high sausage meat-emulsion adhesion is often demanded in order to prevent formation of gel deposits.

According to the present invention, it is especially polyamide-based foodstuff casings that are premoistened so as to be ready-to-fill, and also casings which comprise polyamide in at least one layer. The polyamide is generally aliphatic and/or partly aromatic polyamide. The aliphatic polyamide is preferably a linear aliphatic polyamide, such as PA 6, PA 11, or PA 12, or a linear aliphatic copolyamide, such as PA 6.66, PA 6.9, PA 6.10, PA 6.11, or PA 6.12. It is also possible to use mixtures of polyamides and copolyamides. The multilayer casings generally comprise not only at least one PA layer forming the outer and/or inner surface of the casing but also at least one water-vapor-barrier layer. This is preferably composed of polyolefin(s), such as polyethylene, polypropylene, polybutylene, or else the copolymers composed of ethylene and/or propylene and of a olefins having from 4 to 8 carbon atoms. The polyolefins may have been end-group-modified in order to improve adhesion to adjacent layers, in particular to polyamide layers. Other layers may be present, in particular adhesion layers between PA layers and polyolefin(PO) layers.

Polyamide casings or polyamide layers absorb up to about 6% by weight of water in the interior of the cross section, and this means that water is a swelling agent for polyamides. Because the diffusion process is time-dependent, an excess of the solution for pretreatment with water is applied to the surface. The amount of aqueous solution applied should be from 10 to 150% by weight, preferably from 20 to 100% by weight, based in each case on the weight of the tube. In order to provide uniform preparations, rapid run-off of the solution is to be inhibited, and this means that the composition is to be such that the liquid used for premoistening is “held” on the surface. One way of achieving this is to increase the viscosity or to add an oil emulsion. For viscosity increase, use is especially made of polyhydric alcohols, such as glycerol or sorbitol, and also of polyacrylic acids or of other thickeners; suitable oils are especially natural oils, such as olive oil, rapeseed oil, or sunflower oil, or else synthetic triglycerides (obtainable, by way of example, as ®Softenol). They may be added at a concentration of from 1 to 40%, preferably from 2 to 15%, to the preparation solution. The viscosity is advantageously adjusted so that the solution can be applied without difficulty by spraying.

The internal water pretreatment can be combined with an easy-peel preparation to improve peelability, by treating the preparation solution, which at this stage comprises an oil emulsion, with the known easy-peel-action components. Components which may especially be used for this purpose are cellulose derivatives and starch derivatives, alginates, and chitosan. They are used at a concentration of from 0.1 to 8%, preferably from 0.5 to 2.5%. At higher concentrations, the grades to be used are those of correspondingly low viscosity, e.g. carboxymethylmethyl-, hydroxyethyl-, or methylhydroxyethylcellulose-10, -20, or -30.

The casings prepared internally and/or externally with the moistening solution are advantageously stored for from 1 to 2 weeks prior to further processing in order to provide uniform diffusion within the cross section of the casings and therefore to provide defect-free processing.

Water-pretreatment of polymer-based casings, especially internally, have hitherto been regarded as impossible. It is now possible without additional cost by using this simple step of a process prior to finishing processes. This single step, i.e. the application of the preparation solution, simultaneously achieves water-pretreatment and preservation, and also, if appropriate, provides easy peelability.

This preparation can be carried out under hygienic conditions, whereas that is certainly not ensured during prolonged water-treatment of the shirred sticks or sections in processing plants.

The examples below serve to illustrate the invention. Percentages given in the examples are percentages by weight unless otherwise stated or otherwise apparent from the context.

### EXAMPLE 1

A biaxially oriented, three-layer tube with a polyamide/polyethylene/polyamide structure and a diameter of 90 mm (=caliber 90) was sprayed internally and externally, during shirring, with a solution of the following composition:
94.50 l of water
2.00 kg of Na salt of methyl para-hydroxybenzoate
3.50 kg of glycerol

The amount for spraying was adjusted so that the increase in weight of the tube was about 35%.

After the shirred sticks had been stored for two weeks, sufficient water had diffused into the PA layers to permit problem-free and crease-free stuffing. The shirred sticks were capable of storage for any desired period without infestation by mold or bacteria.

### EXAMPLE 2

A single-layer, oriented PA tube of caliber 60 was sprayed internally and externally with the following solution, during shirring:
91.501 of water
2.00 kg of propane-1,2-diol
0.50 kg of Na salt of propyl para-hydroxybenzoate

The amount for spraying was adjusted so that the increase in weight of the tube was about 40%. The resultant shirred sticks could be stuffed without creasing and without additional water treatment; even after prolonged storage (two or more months), no infestation by mold or bacteria was observed.

### EXAMPLE 3

An unoriented polyamide tube (UPA) of caliber 105 was sprayed internally and externally with the following solution during shirring, for processing without water-treatment:
88.00 l of water
1.0 kg of methyl para-hydroxybenzoate,
1.0 kg of Na salt of propyl para-hydroxybenzoate, and
10.0 kg of triglyceride (®Softenol) emulsion (50% strength in water).

The amount of spraying was adjusted so that the increase in weight of the tube was about 32% (same amount internally and externally).

The shirred sticks were capable of practically unlimited storage. They could be stuffed without creasing and without further water-treatment.

### EXAMPLE 4

A biaxially oriented, three-layer, tubular casing with a polyamide/polyethylene/polyamide structure (®Nalobar from Kalle GmbH & Co. KG) of caliber 60 was sprayed on the outer side with a solution as in Example 2 and on the inner side with the following solution
97.30 l of water
2.0 kg of carboxymethylcellulose (®Tylose C30 from Clariant Deutschland GmbH),
2.0 kg of a 50% strength aqueous triglyceride emulsion®Softenol),
2.0 kg of Na salt of methyl para-hydroxybenzoate, and
0.4 kg of lecithin.

The amount for spraying was adjusted so that the increase in weight of the tube was about 42%. The shirred sticks produced from the tube were then surrounded with a water-vapor-impermeable film and stored for two or more months. After storage, no infestation with mold or bacteria was discernible. The casing could easily be peeled away from the sausages produced therewith.

### EXAMPLE 5

A biaxially oriented, three-layer tube with a polyamide/polyethylene/polyamide structure (®Nalobar) of caliber 60 was passed through a saturation trough in which there was a solution as in Example 2. During shirring, the tube was then sprayed on the outer side with paraffin oil and on the inner side with the following solution
97.30 l of water,
2.0 kg of carboxymethylcellulose (®Tylose C30 from Clariant Deutschland GmbH),
2.0 kg of a 50% strength aqueous triglyceride emulsion (®Softenol),
2.0 kg of Na salt of propyl para-hydroxybenzoate, and
0.4 kg of a diketene having straight-chain (C₁₄-C₂₀)alkyl radicals (®Aquapel).

The amount for spraying was adjusted so that the increase in weight over the tube was about 36%. The shirred sticks produced from the tube were then surrounded with a water-vapor-impermeable film and stored for two or more months. After storage, no infestation with mold or bacteria was discernible. The casing could easily be peeled away from the sausages produced therewith, without any adherent residues of sausage meat emulsion.

1. An antimicrobial, tubular, single- or multilayer polymer-based plastics foodstuff casing premoistened so as to be ready-to-fill, which comprises, as antimicrobial constituent, an alkyl para-hydroxybenzoate and/or a salt thereof.

2. The foodstuff casing as claimed in claim 1, wherein the alkyl para-hydroxybenzoate or its salt contains from 1 to 10, carbon atoms in an alkyl moiety.

3. The foodstuff casing as claimed in claim 1, wherein the alkyl para-hydroxybenzoate and/or its salt has been combined with at least one other antimicrobial agent.

4. The foodstuff casing as claimed in claim 3, wherein the other antimicrobial agent is an agent which reduces water activity.

5. The foodstuff casing as claimed in claim 4, wherein the agent which reduces water activity is glycerol or propanediol.

6. The foodstuff casing as claimed in claim 1, wherein an inner side thereof is impregnated with at least one component which improves peelability.

7. The foodstuff casing as claimed in claim 6, wherein the component which improves peelability is a cellulose derivative or starch derivative, an alginate, or chitosan.

8. A process for the production of the foodstuff casing as claimed in claim 1, which comprises premoistening the casing with an aqueous solution in which the proportion of all of the antimicrobial agents together is from 0.1 to 8% by weight, based on the weight of the solution.

9. The process as claimed in claim 8, wherein the alkyl para-hydroxybenzoate and/or its salt is applied in one step with the water serving for premoistening the an inner and/or outer side of the casing.

10. The process as claimed in claim 9, wherein the aqueous solution is applied by spraying.

11. The process as claimed in claim 10, wherein the aqueous solution is applied with the aid of a spray mandrel to an inner side of the casing, while said casing is shirred.

12. The process as claimed in claim 11, wherein the aqueous solution comprises at least one component which makes the casing easy to peel.

13. A synthetic sausage-casing comprising a casing of claim 1.

14. A casing of claim 2 having 1 to 6 carbon atoms in the alkyl moiety.

15. A casing of claim 2 having 2 to 5 carbon atoms in the alkyl moiety.

16. The foodstuff casing as claimed in claim 2, wherein the alkyl para-hydroxybenzoate and/or its salt has been combined with at least one other antimicrobial agent.

17. A process of claim 8, wherein said antimicrobial agents are present in a proportion from 0.2 to 2% by weight based on the weight of the solution.

18. A process for the production of the foodstuff casing as claimed in claim 2, which comprises premoistening the casing with an aqueous solution in which the proportion of all of the antimicrobial agents together is from 0.1 to 8% by weight, based on the weight of the solution.

19. A process for the production of the foodstuff casing as claimed in claim 3, which comprises premoistening the casing with an aqueous solution in which the proportion of all of the antimicrobial agents together is from 0.1 to 8% by weight, based on the weight of the solution.

20. A synthetic sausage-casing comprising a casing of claim 2.
